(19) United States
(12) Patent Application Publication
(10) Pub. No.: US 2010/0191688 A1
(43) Pub. Date: Jul. 29, 2010

(54) DYNAMIC CONSTRAINT SOLVER WITH RESOURCE SUM CONSTRAINTS

(75) Inventors: Gao Chen, Beijing (CN); Claire M. Bagley, Carlisle, MA (US)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/362,209

(22) Filed: Jan. 29, 2009

(51) Int. Cl. G06N 5/02

(52) U.S. Cl. 706/46

(57) ABSTRACT

A solver for solving a dynamic constant satisfaction problem that includes a resource sum constraint and a port for coupling zero or more sub-problems to the problem. The solver couples a new sub-problem to the port. The solver then, based at least on the coupling, determines a revised resource sum domain for the problem, the revised resource sum domain including a contribution from existing participants and a contribution from potential participants.

### FIELD OF THE INVENTION

One embodiment is directed generally to a computer system, and in particular to a constraint based computer system that solves dynamic constraint satisfaction problems.

### BACKGROUND INFORMATION

Many of the tasks that are addressed by decision-making systems and artificial intelligence systems can be represented as constraint satisfaction problems (“CSP”s). In this representation, the task is specified in terms of a set of variables, each of which can assume values in a given domain, and a set of constraints that the variables must simultaneously satisfy. The set of variables, domains and constraints is referred to as a CSP. Each constraint may be expressed as a relation, defined over some subset of the variables, denoting valid combinations of their values. A solution to a CSP is an assignment of a value to all the variables from their respective domains that satisfies all of the constraints.

A constraint based system includes a constraint solver that attempts to find one or more solutions to a given CSP, or prove that no solution exists. Constraint based systems are used for many artificial intelligence related applications and a variety of other applications, including: (1) Product configurators; (2) Robotic control; (3) Temporal reasoning; (4) Natural language processing; (5) Spatial reasoning; (6) Test-case generation for software and hardware systems; (7) Machine vision; (8) Medical diagnosis; (9) Resource allocation; and (10) Frequency allocation.

The network of constraints in a CSP can be viewed as a graph, having a node for each variable and “arc” for each constraint. The members of each arc are the variables that appear in the constraint to which the arc corresponds. An arc is said to be consistent if for any variable of the arc, and any value in the domain of the variable, there is a valid assignment of values to the other variables on the arc that satisfies the constraint represented by the arc.

Classes of problems exist which are comprised of very large sets of variables that may only be conditionally related or required for a solution. One example of such problems is the configuration of large component-based systems. For example, selecting a type of hard disk controller for a computer configuration is not needed if a hard disk has not been chosen as a form of storage. If instead flash memory is chosen, a different set of variables and constraints would be required to be solved. Known CSP solvers do not allow the representation of conditional structure or reasoning over an inclusion of a variable in a solution. Techniques have been developed to allow such large problems to be represented as a set of smaller sub-problems, conditionally related through composition or association. A “dynamic constraint satisfaction problem” is one in which these sub-problems of variables and constraints can be incrementally added as required, either explicitly or as a result of inference from the propagation of constraints.

One known approach to minimize large CSP problems is referred to as “Conditional CSP”, and includes the notion of a variable being active or inactive, as well as constraints to activate a variable. In this approach, a variable is only assigned a value in the final solution if it is active. Conditional CSP is limited in that it does not provide any significant space savings in large problems, nor does it allow for segmentation of related variables into sub-problems. Another known approach is referred to as “Generative CSP” and extends Conditional CSP by introducing the concept of components, which are groups of related variables, and component type, which is the further extension and specialization of these components. However, similar to Conditional CSP, Generative CSP is still implemented in terms of activity state and does not provide real space savings.

### SUMMARY OF THE INVENTION

One embodiment is a solver for solving a dynamic constant satisfaction problem that includes a resource sum constraint and a port for coupling zero or more sub-problems to the problem. The solver couples a new sub-problem to the port. The solver then, based at least on the coupling, determines a revised resource sum domain for the problem, the revised resource sum domain including a contribution from existing participants and a contribution from potential participants.

### BRIEF DESCRIPTION OF THE DRAWINGS

FIG. 1 is a block diagram of a dynamic constraint based system that can implement an embodiment of the present invention.

FIG. 2 illustrates the hierarchy of a dynamic constraint problem in accordance with one embodiment.

FIG. 3 is a flow diagram of the functionality of the dynamic constraint solver module when performing consistency checking on a resource sum constraint.

### DETAILED DESCRIPTION

One embodiment is a dynamic constraint based system that models a problem as a Constraint Satisfaction Problem by defining sub-problems of problems and applying a resource sum constraint to a problem or a port. Based on the resource sum constraint, the system can generate a new sub-problem or can restrict the cardinality of a port.

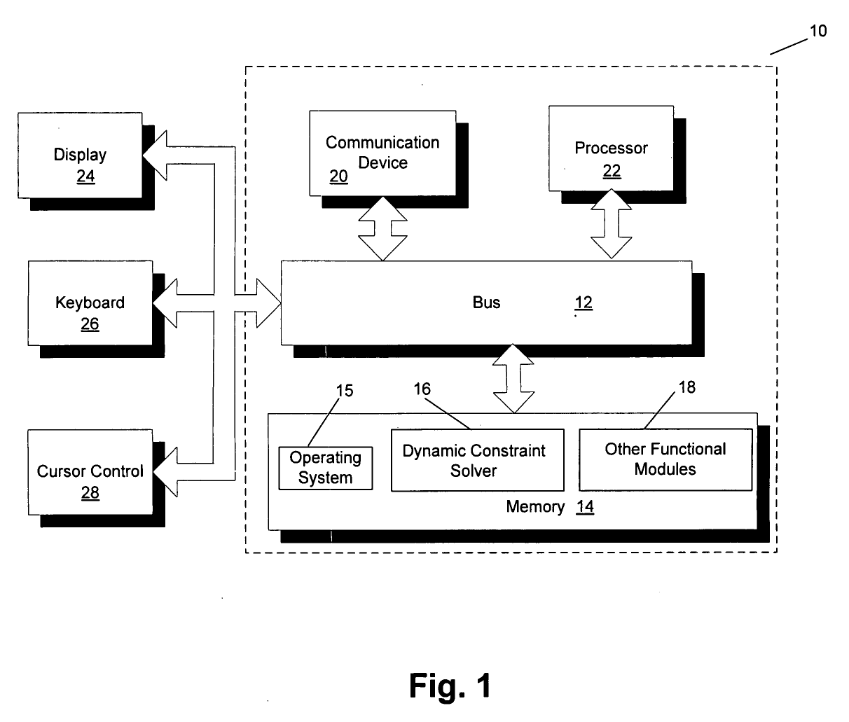

FIG. 1 is a block diagram of a dynamic constraint based system 10 that can implement an embodiment of the present invention. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include a dynamic constraint solver module 16 that performs dynamic constraint solving with resource sum constraints as disclosed in more detail below. System 10 can be part of a larger system that includes a constraint solver, such as a product configurator or artificial intelligence system. Therefore, system 10 will typically include one or more additional functional modules 18 to include the additional functionality.

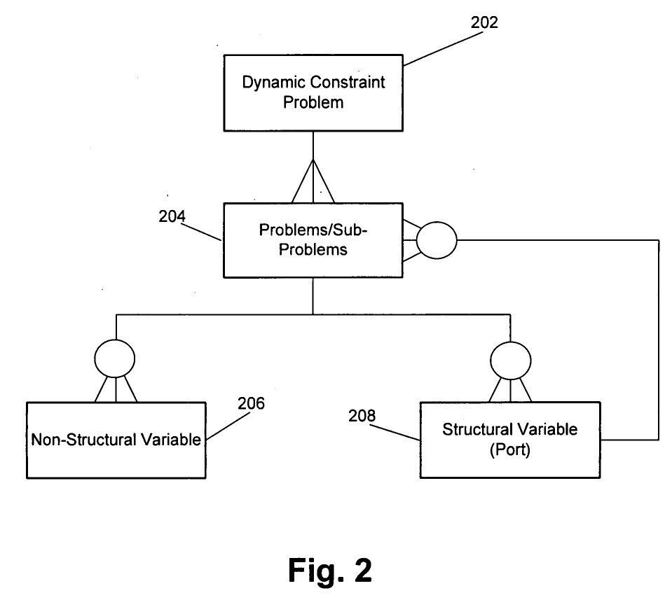

FIG. 2 illustrates the hierarchy of a model of a dynamic constraint problem 202 in accordance with one embodiment. The dynamic constraint problem 202 includes one or more problems or sub-problems 204 (a “sub-problem” may also be a “problem”, and vice versa depending on where it falls in the hierarchy). In an embodiment where the dynamic constraint problem is for a product configurator, the problems/sub-problems are the components/sub-components of the configurator.

Each problem is formed of zero or more non-structural variables 206. Examples of non-structural variables 206 includes Boolean variables, integers, floating point variables, etc. Each problem 204 may also include zero or more structural variables or “ports” 208. A port is a container for problems and connects sub-problems to the problem or to another sub-problem. Each port 208 can be connected to zero or more sub-problems 204. A port may be defined by two items: (a) the definition of the problem to be connected to the port; and (b) a numeric domain representing how many instances of the problem is required or allowed in the port (referred to as the port's “cardinality”).

For example, a problem definition for problem A may be as shown in Example 1 below (the bracketed information indicates the domain for the problem/port):

ProblemA
|_Required Resource [0..100]
|_Port to ProblemB [0..5]
|_Resource [1..10]

### EXAMPLE 1

As shown in the definition, Problem A includes a “Required Resource” non-structural variable and a port to Problem B. According to that port, Problem A may include zero to five Problem Bs. Each Problem B is defined with an amount of Resource [1 . . . 10] that it can provide to a resource sum, which is the sum of all resources of Problem Bs that are connected to the port to Problem B. The cardinality domain for the port to Problem B is [0 . . . 5].

In one embodiment, solver 16 can generate problems dynamically through constraints. A resource sum constraint computes the sum of all resources provided by the problems within a port, and when there is a requirement (i.e., a Required Resource variable) on the sum that cannot be fulfilled by the existing problems, it will drive the instantiation of new problems in one embodiment.

For example, assume there is the following constraint for Example 1 above: “Required resource=sum of all resources on problems in Port to Problem B.” At the outset, when there is no Problem Bs instantiated yet, the domain of Required Resource should be reduced to [0 . . . 50] since there can be 0 to 5 Problem Bs, each may contribute 1 to 10 to the sum. The minimum case is when there is no Problem B at all. The maximum case is when there are 5 Problem Bs, each which provides a resource of 10.

Now assume one Problem B is instantiated and its Resource is set to 5. The domain of Required Resource should be further reduced to [5 . . . 45] since in addition to the 5 contributed by the existing Problem B, there can be 0 to 4 more Problem Bs, each of which may contribute 1 to 10 to the sum. Therefore, the contribution from potential instances of Problem B is [0 . . . 40], plus the 5 from the existing instance of Problem B, results in [5 . . . 45].

Now assume the Required Resource is set to 6. One more Problem B should be instantiated since the existing one only provides 5. Additionally, the Resource on this new instance of Problem B should be set to 1 since that is the only valid value to meet the resource sum constraint. Anything greater than 1 will make the sum go beyond 6.

A “resource” can be any variable that can be aggregated to form a sum. For example, a dynamic constraint solver can be used by a product configurator to configure a computer system card cage that includes multiple ports for accepting pluggable device cards. Assume that the computer cage has a maximum of 5 watts of power to be supplied to all of the cards. Each card has a characteristic of power requirement. Each card can be separately configurable. In this example, the cage is a first component/problem with a required resource domain of 0-5 watts. Each port can be coupled to one or more sub-components (i.e., the cards). The configurator must maintain a resource sum constraint that the sum of all card power requirements is less than or equal to 5 watts.

In one embodiment, solver 16 creates resource sum constraints, and can efficiently reason over the constraints. The resource sum can be determined from two parts: contribution from existing participants and contribution from potential participants. In order to determine contributions for existing participants, the actual contribution is computed. Whenever an instance is generated in a port, the resource sum will include the new participant into the computation of contribution from existing participants.

For example, as shown in Example 2 below, assume the same problem definition as Example 1 above, and also assume a Problem B1 is created with its Resource set to 3. The contribution from existing participants is then 3:

```
ProblemA
|_Required Resource [3..43]
|_Port to ProblemB [1..5]
  |_ProblemB1
    |_Resource [3]
```

### EXAMPLE 2

Next, as shown in Example 3 below, assume the same problem definition as Example 1 above, and also assume that a Problem B1 is created with its Resource set to 3, and a Problem B2 is created with its Resource unrestricted, thus having a domain of [1 . . . 10] as defined. The contribution from existing participants is then 3+[1 . . . 10]=[4 . . . 13].

```
ProblemA
|_Required Resource [4..43]
|_Port to ProblemB [2..5]
  |_ProblemB1
  ||_Resource [3]
  |_ProblemB2
    |_Resource [1..10]
```

### EXAMPLE 3

To compute the contribution from potential participants, in one embodiment solver 16 determines a “potential contribution to the sum/aggregate” domain (referred to as “potential contribution” domain) whose lower bound represents the minimum possible contribution from potential participants, and whose upper bound represents the maximum possible contribution from potential participants.

As an example of the “potential contribution”, as shown in Example 4 below, assume the same problem definition as Example 1 above and also assume a Problem B1 is already created in the port. Now the cardinality domain is [1 . . . 5], meaning in the end solution, there must be at least one Problem B (i.e., Problem B1), and there can be at most 5 Problem Bs.

In addition to the existing Problem B1, there can be from 0 to 4 potential Problem Bs. From Problem B's definition, it is known that each potential Problem B could have a Resource contributing [1 . . . 10] to the sum. Therefore, the total contribution from potential participants can be somewhere between 0 and 40. The “potential contribution” domain is then [0 . . . 40].

```
ProblemA
|_Required Resource [3..43]
|_Port to ProblemB [1..5]
  |_{—} ProblemB1
    |_Resource [3]
```

### EXAMPLE 4

After computing the contribution from existing participants and the contribution from potential participants, the Resource Sum's domain is the sum of the two. For example, as shown in Example 5 below, assume the same problem definition as Example 1 above. Also assume a Problem B1 is created with its Resource set to 3, and the cardinality domain for the port is [1 . . . 5]. The contribution from existing participants has already be determined as 3, and the contribution from potential participants as [0 . . . 40]. Therefore the Resource Sum's domain is 3+[0 . . . 40]=[3 . . . 43], meaning that in the end solution, the Resource Sum must be at least 3 but not exceeding 43.

```
ProblemA
|_Required Resource [3..43]
|_Port to ProblemB [1..5]
  |_{—} ProblemB1
    |_Resource [3]
```

### EXAMPLE 5

In one embodiment, when the resource sum's domain is reduced, it can also reduce the potential contribution domain, which may lead to component generation. For example, as shown in Example 6 below, assume the same problem definition as Example 1 above and also assume a Problem B1 is created with its Resource set to 3, and the cardinality domain for the port is [1 . . . 5].

```
ProblemA
|_Required Resource [3..43]
|_Port to ProblemB [1..5]
  |_ProblemB1
    |_Resource [3]
```

### EXAMPLE 6

The Resource Sum [3 . . . 43]=3+[0 . . . 40], where 3 is the contribution from Problem B1, and [0 . . . 40] is the potential contribution domain representing contribution from potential participants.

Now assume Required Resource is set to 15. Since the Required Resource=sum of all Resources on problems in Port to Problem B, the Resource Sum's domain is reduced to 15. It can be determined that out of the 15, 3 is contributed by Problem B1, so then the rest, which is 12, must be the contribution from potential instances.

Since each Problem B can contribute at most 10 by definition (10 is the maximum value allowed for Resource), there must be at least 2 more Problem Bs in order to contribute 12 to the sum. Solver 16 will generate 2 more Problem Bs and the structure will now look like Example 7 below:

```
ProblemA
|_Required Resource [15]
|_Port to ProblemB [3..5]
  |_Problem B#1
  ||_Resource [3]
  |_Problem B#2
  ||_Resource [1..10]
  |_ProblemB#3
    |_Resource [1..10]
```

### EXAMPLE 7

In one embodiment, when the Resource Sum's domain is reduced, it can also reduce the domain of existing participants. For example, as shown in Example 8 below, assume the same problem definition as Example 1 above and also assume a Problem B1 is created with its Resource set to 3, and a Problem B2 is created with its Resource unrestricted, thus it has a domain of [1 . . . 10] as defined.

```
ProblemA
|_Required Resource [4..43]
|_Port to ProblemB [2..5]
  |_ProblemB#1
  ||_Resource [3]
  |_ProblemB#2
    |_Resource [1..10]
```

### EXAMPLE 8

The contribution from existing participants is 3+[1 . . . 10]=[4 . . . 13]. The contribution from potential participants is [0 . . . 30] since there can be 0 to 3 potential Problem Bs, each contributing 0 to 10. The Resource Sum is 3+[1 . . . 10]+[0 . . . 30]=[4 . . . 43].

Now assume Required Resource is set to 10. Since Required Resource=sum of all Resources on components in Port to Problem B, the Resource Sum's domain is reduced to 10. Now for Problem B2, its Resource cannot have any value greater than 7, otherwise, together with the contribution from Problem B1 which is 3, the sum will go beyond 10. Therefore, the domain of Resource in Problem B2 is reduced from [1 . . . 10] to [1 . . . 7] as shown in Example 9 below.

```
ProblemA
|_Required Resource [10]
|_Port to ProblemB [2..5]
  |_Problem B#1
  ||_Resource [3]
  |_ProblemB#2
    |_Resource [1..7]
```

### EXAMPLE 9

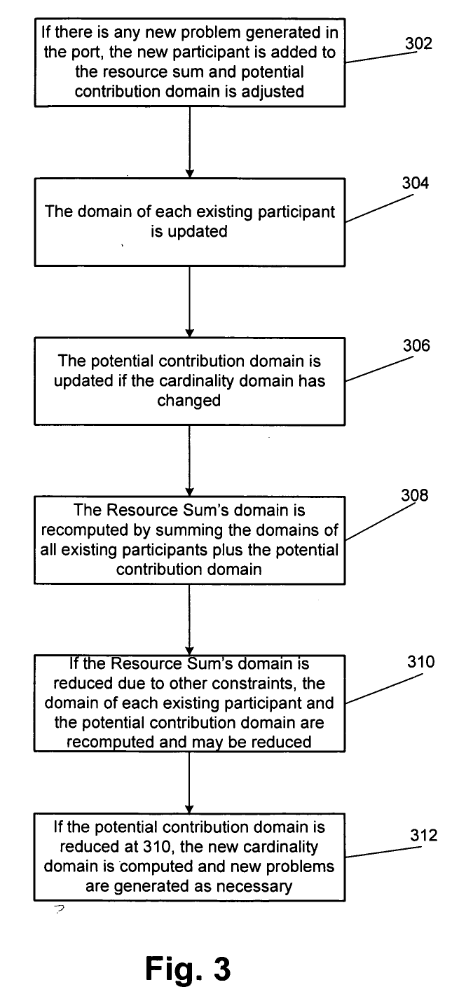

FIG. 3 is a flow diagram of the functionality of dynamic constraint solver module 16 when performing consistency checking on a resource sum constraint. In one embodiment, the functionality of the flow diagram of FIG. 3 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 302, if there is any new problem generated in the port, the new participant is added to the resource sum and potential contribution domain is adjusted since now there is one less potential problem.

At 304, the domain of each existing participant is updated since it may be reduced by other constraints or the user.

At 306, the potential contribution domain is updated if the cardinality domain has changed since this will affect how many potential problems are allowed.

At 308, the Resource Sum's domain is recomputed by summing the domains of all existing participants plus the potential contribution domain.

At 310, if the Resource Sum's domain is reduced due to other constraints, the domain of each existing participant and the potential contribution domain are recomputed and may be reduced.

At 312, if the potential contribution domain is reduced at 310, the new cardinality domain is computed and new problems are generated as necessary.

As disclosed, a dynamic constraint solver in one embodiment applies a resource sum constraint to a port. A potential contribution for the resource sum is tracked and adjusted when a new problem is coupled to the port. The reduction of the resource variable's domain on an existing problem, the addition of a new problem, or the reduction of the port's cardinality domain, may reduce the domain of the resource sum and may also cause the cardinality of the port to be revised and new problems to be generated.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable media having instructions stored thereon that, when executed by a processor, causes the processor to solve a dynamic constant satisfaction problem, the problem comprising a resource sum constraint and a port for coupling zero or more sub-problems to the problem, the functionality of the instructions comprising:
coupling a first sub-problem to the port; and
based at least on the coupling, determining a revised resource sum domain for the problem, the revised resource sum domain comprising a contribution from existing participants and a contribution from potential participants.

2. The computer readable media of claim 1, further comprising:
if the revised resource sum domain is reduced due to a first constraint, recomputing the contribution from existing participants and the contribution from potential participants based at least in part on the reduced domain.

3. The computer readable media of claim 2, further comprising:
if the contribution from potential participants is reduced from the recomputing, computing a revised cardinality domain for the port.

4. The computer readable media of claim 2, further comprising:
if the contribution from potential participants is reduced from the recomputing, generating a second sub-problem coupled to the port.

5. The computer readable media of claim 1, wherein the constraint satisfaction problem is a product configurator and the sub-problems are components of the configurator.

6. The computer readable media of claim 1, wherein the contribution from existing participants comprises a total of resources of sub-problems coupled to the port.

7. The computer readable media of claim 1, wherein the contribution from potential participants is based at least on a cardinality domain of the port and a domain definition of a resource variable on the first sub-problem.

8. A computer implemented method for solving a dynamic constant satisfaction problem, the problem comprising a resource sum constraint and a port for coupling zero or more sub-problems to the problem, the method comprising:
coupling a first sub-problem to the port; and
based at least on the coupling, determining a revised resource sum domain for the problem, the revised resource sum domain comprising a contribution from existing participants and a contribution from potential participants.

9. The method of claim 8, further comprising:
if the revised resource sum domain is reduced due to a first constraint, recomputing the contribution from existing participants and the contribution from potential participants based at least in part on the reduced domain.

10. The method of claim 8, further comprising:
if the contribution from potential participants is reduced from the recomputing, computing a revised cardinality domain for the port.

11. The method of claim 8, further comprising:
if the contribution from potential participants is reduced from the recomputing, generating a second sub-problem coupled to the port.

12. A constraint solver for solving a dynamic constant satisfaction problem, the problem comprising a resource sum constraint and a port for coupling zero or more sub-problems to the problem, the solver comprising:
means for coupling a first sub-problem to the port; and
based at least on the coupling, means for determining a revised resource sum domain for the problem, the revised resource sum domain comprising a contribution from existing participants and a contribution from potential participants.

13. A dynamic constraint solver comprising:
a processor;
a memory coupled to the processor, the memory storing a constraint satisfaction problem model that comprises a resource sum constraint and at least one port for coupling at least one sub-problem to a problem;
a dynamic constraint solver module coupled to the memory; the solver module adapted to coupled a first problem to the port; and
based at least on the coupling, determine a revised resource sum domain for the problem, the revised resource sum domain comprising a contribution from existing participants and a contribution from potential participants, and if the revised resource sum domain is reduced due to a first constraint, recomputing the contribution from existing participants and the contribution from potential participants based at least in part on the reduced domain.

14. The solver of claim 13, further comprising:
if the contribution from potential participants is reduced from the recomputing, computing a revised cardinality domain for the port.

15. The solver of claim 13, further comprising:
if the contribution from potential participants is reduced from the recomputing, generating a second sub-problem coupled to the port.

16. The solver of claim 13, wherein the solver is a product configurator and the sub-problems are components of the configurator.
